(19) United States
(12) Patent Application Publication
(10) Pub. No.: US 2004/0212113 A1
(43) Pub. Date: Oct. 28, 2004

(54) Methods and devices for applying substances to the inner surface of the bubble during blown-film extrusion

(76) Inventors: Tomas Nestor Hasing, Riobamba (EC); Julio Eduardo Hasing, Riobamba (EC)

Correspondence Address: Tomas N. Hasing, Buenos Aires 1310, Barrio Bellavista, Riobamba, EC

(21) Appl. No.: 10/722,252

(22) Filed: Nov. 22, 2003

Related U.S. Application Data
(60) Provisional application No. 60/447,275, filed on Feb. 14, 2003.

(51) Int. Cl. B05D 7/22; B05D 1/02

(52) U.S. Cl. 264/5; 427/230; 118/622; 425/7; 425/72.1; 264/565; 264/563

(57) ABSTRACT

Selected substances are applied to the inner surface of the bubble during blown-film extrusion, with the intent of altering the physical, chemical or biological properties of resin films manufactured by the extrusion process. Preferred embodiments of the invention are disclosed, wherein a fluid preparation of selected substances is atomized from a point on the longitudinal axis of the bubble by one atomizing apparatus fixed on top of the die mandrel of a blown-film extruder. In the embodiments described, the atomizing apparatus is: (1) a tube that delivers fluid in a continuous manner to the center of the top surface of a spinning disc that atomizes the fluid towards the inner surface of the film bubble, or (2) a plurality of spraying nozzles connected to a tube that delivers the fluid to be atomized, and oriented to spray towards the inner surface of the film bubble.

### CROSS-REFERENCE TO RELATED APPLICATIONS This application claims the benefit of U.S. Patent Application No. 60/447,275 filed on Feb. 14, 2003.

### STATEMENT REGARDING FEDERALLY SPONSORED RESEARCH OR DEVELOPMENT

Not Applicable

### BACKGROUND OF THE INVENTION

The disclosure herein relates to the modification of the physical, chemical or biological properties of resin films manufactured by blown-film extrusion. Blown-film extrusion is the process where a molten polymer is fed through the gap of a die under controlled temperature and pressure conditions, to emerge as a tubular structure that is shaped into a bubble by blowing air into its interior.

One of the methods available to modify the properties of resin films manufactured by blown-film extrusion comprises treating the polymer with selected substances possessing physical, chemical or biological activity. In the past, such treatment has been accomplished by mixing the polymer with a preparation of active substances before extrusion (U.S. Pat. Nos. 4,167,503; 4,490,323; 5,308,395; 5,516,814; 6,013,222). This approach has the disadvantage of being inefficient when the active substances are prone to degradation under the temperature and pressure conditions existing inside the extruder (140-205° C. and 1000-5000 p.s.i.). Any technique or device that can alleviate or overcome this degradation problem would facilitate wider use of such active substances and be a boon to the industry.

### BRIEF SUMMARY OF THE INVENTION

Problems in this field, and particularly the problem of active substance degradation by temperature and/or pressure, are alleviated by devices and methods of the invention as described herein. Many embodiments concern methods and devices for the controlled application of selected substances possessing physical, chemical and/or biological activity to the inner surface of the bubble during blown-film extrusion. Generally, temperature and/or pressure are significantly lower in the bubble than inside the extruder. Without wishing to be bound by any one theory of embodiments of the invention, it is believed that substances which are prone to degradation under the high temperatures and pressures typical of the inside of an operating extruder are applied at lower temperature and/or pressure. Embodiments of the invention are particularly useful for the controlled application of such substances, which generally cannot be mixed with the polymer before extrusion as losses due to degradation make the process inefficient.

### BRIEF DESCRIPTION OF THE SEVERAL VIEWS OF THE DRAWINGS

FIG. 1 is a sectional view of the head of a blown-film extruder, showing the preferred location of an atomization device for the controlled application of selected substances to the inner surface of the film bubble from a point on the longitudinal axis of the bubble.

FIG. 2 is a sectional view of a preferred embodiment of a rotary atomizing apparatus affixed to the top of the die mandrel of a blown-film extruder as depicted in FIG. 1, showing a tube that delivers fluid in a continuous manner to an indentation in the center of the top surface of a spinning, concave disc, that atomizes the fluid towards the inner surface of the film bubble.

FIG. 3 is a partial view showing a modified form of construction of the embodiment depicted in FIG. 2, where the top surface of the disc has no central indentation.

FIG. 4 is a partial view showing a modified form of construction of the embodiment depicted in FIG. 2, where the top surface of the disc is flat instead of concave.

FIG. 5 is a partial view showing a modified form of construction of the embodiment depicted in FIG. 2, where the top surface of the disc is flat instead of concave and has no central indentation.

FIG. 6 is a sectional view of a preferred embodiment of a nozzle-based atomizing apparatus affixed to the top of the die mandrel of a blown-film extruder as depicted in FIG. 1, showing a plurality of spraying nozzles connected to a tube that delivers the fluid to be atomized, and oriented to spray towards the inner surface of the film bubble.

FIG. 7 is an aerial view of the embodiment portrayed in FIG. 6.

FIG. 8 shows detailed views of a single nozzle of the embodiment portrayed in FIG. 6, depicting frontal, lateral and sectional views of the nozzle, and lateral and sectional views of its individual components.

### DETAILED DESCRIPTION

Embodiments of the invention may be practiced in a wide variety of ways using a wide variety of materials, as a skilled artisan readily will appreciate. For example, application of material to the inner surface of the film bubble during blown-film extrusion may be achieved by modifying one or more characteristics of the material such as temperature, pressure, viscosity, surface tension and content of solvents, and by atomizing the material with one or more “atomizers” such as sprayers, sonicators, vibrators, volatilizers, mixers, sputterers, fluidizers and so on. The following descriptions of the figures pertain to particularly advantageous embodiments. A skilled reader will appreciate further methods and materials that can be used within the scope of the attached claims.

In one embodiment of the invention, one or more substances are added to the inner surface of a bubble during blown-film extrusion by an atomizer affixed to the die mandrel of the extruder device. Any apparatus that generates an aerosol, fog, haze, mist, particle cloud or vapor may be used as an atomizer for this embodiment of the invention. The atomizer may be located at any position that allows control of both the pattern of application of the material to the bubble and the physical and chemical condition of the film during application of the material. The material to be applied may be a fluid preparation of one or more substances, which may associate to the film in several ways. The material may fuse to the film, dissolve into the film, suspend into the film, stick to the film, and so on.

In an embodiment, more than one atomizer may be used. In another embodiment, the die and/or the die mandrel are modified to allow access to the atomizer(s) during extruder operation.

In a desirable embodiment, the material to be atomized is supplied as one or more fluids through a conduit such as tubing. Most advantageously, the fluid(s) is (are) moved towards an orifice on the die mandrel by action of a pump or other device or other agent. In another embodiment, the conduit is thermally insulated to alleviate undesired heat transfer from or to the material to be atomized.

In another embodiment, the material to be supplied is in a solid or liquid form and is converted into a liquid or gas at the extruder device itself by action of heat, low pressure or chemical reaction, thereby releasing one or more substances onto, into, or in the vicinity (i.e. within 1 meter, preferably within 0.5, 0.25, 0.15, 0.1, 0.050, 0.02, 0.01 or even within 0.005 meters) of the inner surface of the bubble, through an orifice on the die mandrel of the extruder.

Embodiments of the invention can be useful for the manufacture of a broad range of products, due to the possibility of applying a wide array of substances to the film during blown-film extrusion. Some of the selected substances that can be applied to the film are:

Anti-blocking agents, which prevent a film from sticking to itself. Such substances can be used to manufacture bags that are easy to open.

Antimicrobial agents, to manufacture films used to package products susceptible to microbial spoilage such as foodstuffs.

Deodorants.

Electrical conductivity modifiers, to manufacture antistatic films used to package electronic devices sensitive to static electricity.

Radiation filtering agents. One application of such compounds is the manufacture films that filter electromagnetic radiation, such as ultra-violet light.

Fragrances or scents.

Lubricants.

Oxidizers, to manufacture films that neutralize chemical compounds. One application of such films is the manufacture of ethylene-neutralizing bags, which can be used to extend the shelf life of fresh produce.

Pesticides, biocides, insect attractants or plant hormones, to manufacture agricultural films.

Preservatives, such as antioxidants, to manufacture films that can be used to package foodstuffs.

Repellents, to manufacture agricultural films and trash bags.

Rust inhibitors, to manufacture film used to package products susceptible to corrosion.

Sequestering, absorbent, or adsorbent agents, to manufacture films that capture chemical compounds.

Surfactants, to manufacture anti-drip agricultural films and anti-fogging films used to package foodstuffs.

Tackifying agents or cling modifiers, to manufacture self-adhesive packaging films.

Therapeutic agents, such as drugs or hormones, to manufacture films with medicinal or veterinary purposes.

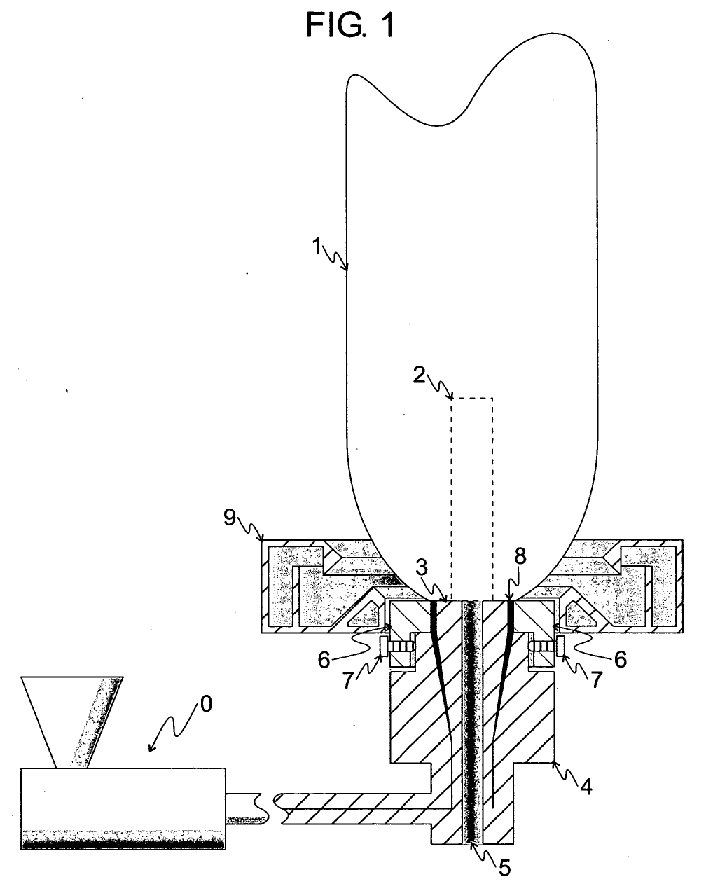

Having described some embodiments of the invention generally, specific desirable embodiments are discussed next in the context of the figures. FIG. 1 is a sectional view of the head of a modified blown-film extruder, showing the preferred location of an atomization device for the controlled application of selected substances to the inner surface of the film bubble. Selected substances possessing physical, chemical or biological activity are applied to the inner surface of the bubble 1 during blown-film extrusion, with an apparatus that atomizes a fluid preparation of the substances from a point located on the longitudinal axis of the bubble. The term “fluid” as used herein means a liquid, a gas, a solid suspended in liquid and/or gas, or a fluidized powder. The preferred location of the atomizing apparatus 2 is on top of the die mandrel 3 of the blown-film extruder, which is inside the bubble during extruder operation.

The die 4 is modified to allow access to the atomizing apparatus from outside the bubble during extruder operation. Such access 5 may allow a tube for delivering the fluid preparation to be atomized to the atomizing apparatus. If the energy required for atomization by the atomizing apparatus is not completely provided by means of the fluid preparation to be atomized, access 5 may allow for a means for transferring the additional energy required. Such means may include, but are not limited to, tubing for high-pressure fluids, electrical wiring or mechanical transmissions. The die must be modified as little as possible in order to preserve its thermodynamic characteristics.

Other parts depicted in FIG. 1 are typical of blown-film extruders, and include the die ring 6, the die adjustment bolts 7, the die gap 8, the air ring 9, and the hopper/barrel section 0.

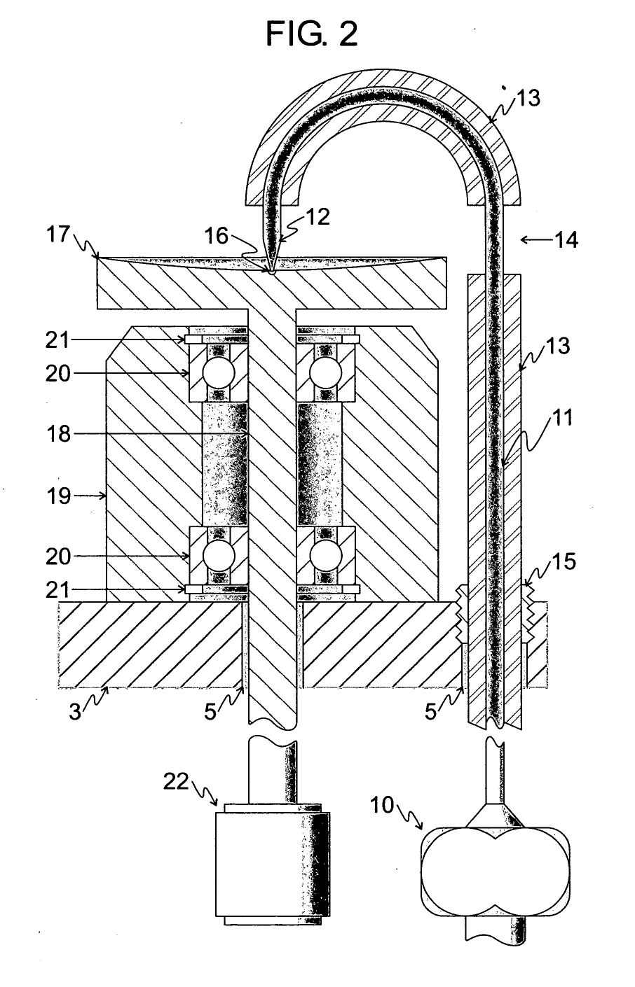

FIG. 2 is a sectional view of a preferred embodiment of a rotary atomizing apparatus, fixed to the top of the die mandrel of a blown-film extruder as depicted in FIG. 1, and consisting of a spinning disc that atomizes a fluid towards the inner surface of the film bubble. In the embodiment, a fluid preparation of a selected substance is propelled by pumping means 10, through a delivery tube 11 that ends in a narrow, open tip 12. The delivery tube is mounted in a hollow, externally treaded cylinder 15 that is screwed into a treaded portion of an access 5 in the die mandrel 3. The delivery tube is partially covered with an insulating material 13 to avoid any undesired heat transfer between either the die and the fluid preparation, or the bubble atmosphere and the fluid preparation. A section of the tube 14 is left uncovered at the level where the fluid is atomized towards the inner surface of the bubble, to reduce interference with atomization. Fluid is delivered in a continuous manner (i.e. without flow interruption) to a small indentation 16, located in the center of the top, concave surface of a disc 17 spinning at 1,000-100,000 r.p.m. The disc 17 atomizes the fluid towards the inner surface of the bubble, and the curvature of its top surface depends on the atomization pattern desired. The function of the indentation 16 is to maintain a droplet of fluid between, and in contact with, the delivery tip 12 and the disc 17. The droplet maintains fluid continuity, insuring a constant rate of delivery during atomization of fluids with relatively low viscosity. The disc 17 is fixed on top of a cylindrical drive shaft 18. The drive shaft is mounted for rotation inside a cylindrical casing 19, by means of ball bearings 20. Bearings are retained in the casing by internal circlip rings 21, and the casing is fixed to the top of the die mandrel 3. The drive shaft 18 is fixed to any appropriate rotation means 22, through an access 5 in the die. Rotation means include, but are not limited to, an electric motor or a pneumatic turbine.

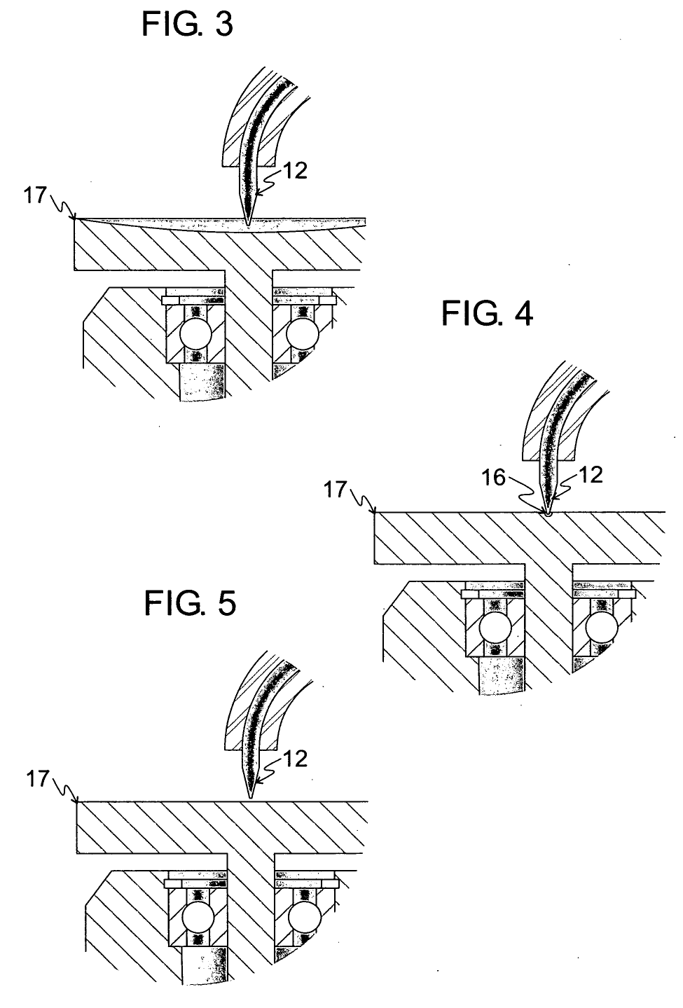

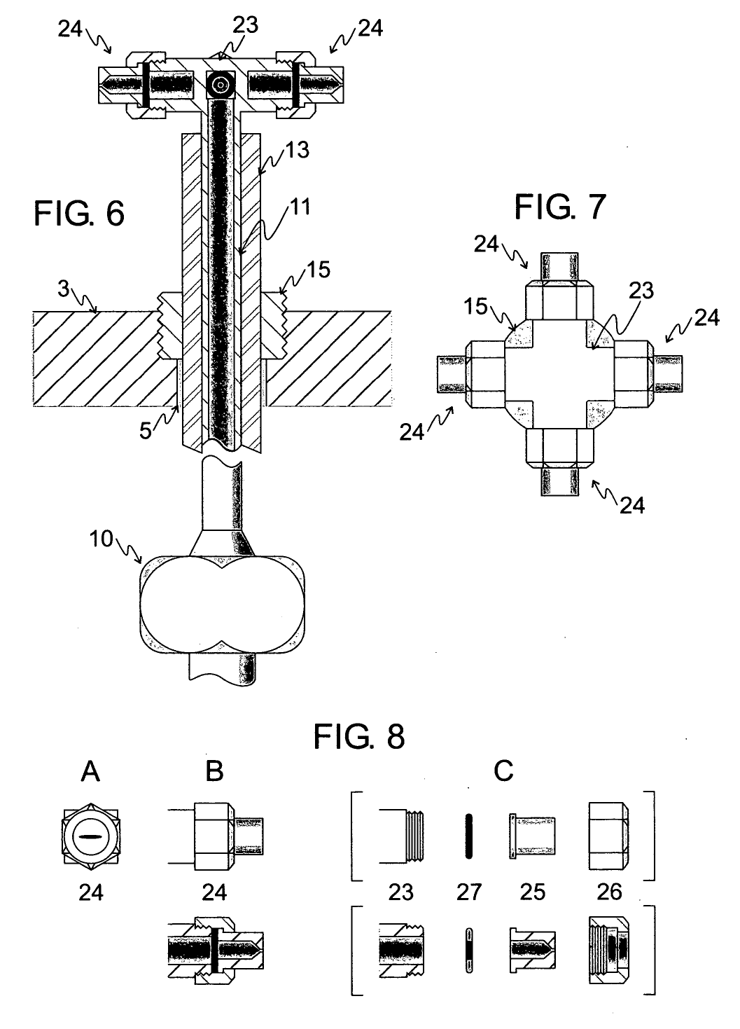

Modified forms of construction of the embodiment depicted in FIG. 2 are shown in FIG. 3 and FIG. 5, where the disc 17 has no central indentation 16, and in FIG. 4 and FIG. 5, where the top surface of the disc 17 is flat. FIG. 6 is a sectional view of a preferred embodiment of a nozzle-based atomizing apparatus, affixed to the top of the die mandrel of a blown-film extruder as depicted in FIG. 1, and consisting of a plurality of spraying nozzles that atomize a fluid towards the inner surface of the film bubble. FIG. 7 is an aerial view of the embodiment portrayed in FIG. 6.

A fluid preparation of a selected substance is pumped by pumping means 10, through a delivery tube 11, to a flow distributor 23. The delivery tube is mounted in a hollow, externally treaded cylinder 15 that is screwed into a treaded portion of an access 5 in the die mandrel 3, and is partially covered with an insulating material 13 to avoid any undesired heat transfer between either the die and the fluid preparation, or the bubble atmosphere and the fluid preparation. The flow distributor dispenses the fluid to a number of nozzles 24, which atomize the fluid towards the film in a horizontal, flat spraying pattern. In this embodiment, four spraying nozzles are used; however, any number of nozzles can be used. The number of nozzles is determined by the aperture angle and the overlap of the spraying patterns of the nozzles.

FIG. 8 shows detailed views of a single nozzle of the atomizing apparatus portrayed in FIG. 6, depicting frontal (A), lateral and sectional (B) views of the nozzle, and lateral and sectional views of its individual components (C). Each nozzle 24 consists of a spraying tip 25 that is fixed to the.flow distributor 23 by means of a retaining nut 26. An 0-ring 27 seals the connection between the flow distributor 23 and the spraying tip 25.

Each of the figures shows structures that are useful for embodiments of the invention.

Any of the described embodiments, alone or in combination, may be used to carry out a method for applying at least one substance to the inner surface of a bubble during blown-film extrusion, comprising the atomization of a fluid preparation of at least one substance at a point on the longitudinal axis of the bubble. The atomization may be performed by at least one atomizing apparatus affixed to the die mandrel of a blown-film extruder. The die and/or the die mandrel may be modified to allow access to at least one atomizing apparatus from outside the bubble during extruder operation. In an embodiment, at least one atomizing apparatus may be a rotary atomization device comprising: a rotating component, which can be any structure, substance or force field suitable to transfer or generate rotational force; a cylindrical part mounted for rotation, with a rotational axis perpendicular to the surfaces of the cylindrical part that have a circular perimeter, the cylindrical part being rotated by the rotating component; a conduit, which guides the fluid to one of the surfaces of the cylindrical part that have a circular perimeter. The conduit may comprise at least one of: tubing; at least one channel in the die mandrel of the blown-film extruder; at least one channel in the rotating component; at least one channel in the cylindrical part. The atomization device may further comprise at least one pumping apparatus coupled to the conduit, the pumping apparatus being any device suitable to impel the fluid through the conduit. The surface receiving the fluid on the cylindrical part may be concave. The surface receiving the fluid on the cylindrical part may have a central indentation where fluid is delivered without flow interruption. The cylindrical part may be a disc. The conduit may be thermally insulated, partially or on its entirety. In another embodiment, at least one atomizing apparatus may be a nozzle-based atomization device comprising: a plurality of spraying nozzles oriented to atomize the fluid towards the inner surface of the bubble; a central flow distributor to which the spraying nozzles are connected; a conduit, which guides the fluid to the flow distributor. The conduit may comprise at least one of the following: tubing; at least one channel in the die mandrel of the blown-film extruder. The atomization device may further comprise at least one pumping apparatus coupled to the conduit, the pumping apparatus being any device suitable to impel the fluid through the conduit. The conduit may be thermally insulated, partially or on its entirety.

At least one substance to be atomized may comprise at least one of the following: a substance that prevents the film from sticking to itself; an antimicrobial substance; a deodorant; a substance that increases the electrical conductivity of the film; a substance that decreases the electrical conductivity of the film; a substance that absorbs electromagnetic radiation of selected wavelengths; a substance that reflects electromagnetic radiation of selected wavelengths; a fragrance or scent; a lubricant; a substance with oxidizing activity; a pesticide; a biocide; an animal attractant; a food preservative; an animal repellent; a rust inhibitor; a substance that decreases the surface tension of liquids; an adhesive substance; a drug; a hormone.

As seen in the figures and described herein, a blown-film extruder is provided, comprising parts typical of a blown-film extruder, including, but not limited to: at least one polymer feeder; at least one extruder screw; at least one die adapter; a die, with a die mandrel and a die ring; at least one air ring; and, at least one atomizing apparatus affixed to the blown-film extruder at a location suitable for placing atomized material on the inner surface of a bubble during blown-film extrusion. At least one atomizing apparatus may be affixed to the die mandrel of the blown-film extruder. In an embodiment, the extruder may include at least one atomizing apparatus as a rotary atomization device, comprising: a rotating component, which can be any structure, substance or force field suitable to transfer or generate rotational force; a cylindrical part mounted for rotation, with a rotational axis perpendicular to the surfaces of the cylindrical part that have a circular perimeter, the cylindrical part being rotated by the rotating component; a conduit, which guides the fluid to one of the surfaces of the cylindrical part that have a circular perimeter. The conduit may comprise at least one of: tubing; at least one channel in the die mandrel of the blown-film extruder; at least one channel in the rotating component; at least one channel in the cylindrical part. In another embodiment, the extruder may include at least one atomizing apparatus as a nozzle-based atomization device, comprising: a plurality of spraying nozzles oriented to atomize the fluid towards the inner surface of the bubble; a central flow distributor to which the spraying nozzles are connected; a conduit, which guides the fluid to the flow distributor. The conduit may comprise at least one of the following: tubing; at least one channel in the die mandrel of the blown-film extruder.

Based on the teachings herein, including the figures, a skilled artisan now can make an improvement to a blown-film extruder to allow the application of at least one substance to the inner surface of a bubble during blown-film extrusion, comprising at least one atomizing apparatus affixed to the extruder at a location suitable for placing atomized material on the inner surface of the bubble during blown-film extrusion. In an embodiment, the improvement may include at least one atomizing apparatus as a rotary atomization device, comprising: a rotating component, which can be any structure, substance or force field suitable to transfer or generate rotational force; a cylindrical part mounted for rotation, with a rotational axis perpendicular to the surfaces of the cylindrical part that have a circular perimeter, the cylindrical part being rotated by the rotating component; a conduit, which guides the fluid to one of the surfaces of the cylindrical part that have a circular perimeter. The conduit may comprise at least one of: tubing; at least one channel in the die mandrel of the blown-film extruder; at least one channel in the rotating component; at least one channel in the cylindrical part. In another embodiment, the improvement may include at least one atomizing apparatus as a nozzle-based atomization device, comprising: a plurality of spraying nozzles oriented to atomize the fluid towards the inner surface of the bubble; a central flow distributor to which the spraying nozzles are connected; a conduit, which guides the fluid to the flow distributor. The conduit may comprise at least one of the following: tubing; at least one channel in the die mandrel of the blown-film extruder.

It is specifically contemplated that one or more features described herein may be added to pre-existing equipment, either for regular business of adding the inventive capability to an apparatus or for continued research and development as part of a scheme to improve an apparatus and/or method. Accordingly, a business engaged in this field may carry out a business related research and development method for determining how to modify a blown-film extruder to apply a substance to the inner surface of a blown bubble, comprising supplying a blown-film extruder; and adding an atomizing apparatus to the blown-film extruder at a location suitable for placing atomized material on the inner surface of a bubble during blown-film extrusion.

Other embodiments will be appreciated by a skilled artisan upon reading this specification and are intended to be included in the scope of the attached claims as well.

All documents referenced herein are specifically incorporated in their entireties by reference.

We claim:

1. A method for applying at least one substance to the inner surface of a bubble during blown-film extrusion, comprising the atomization of a fluid preparation of at least one substance at a point on the longitudinal axis of the bubble.

2. The method of claim 1, wherein atomization is performed by at least one atomizing apparatus affixed to the die mandrel of a blown-film extruder.

3. The method of claim 2, wherein the die and/or the die mandrel are modified to allow access to at least one atomizing apparatus from outside the bubble during extruder operation.

4. The method of claim 2, wherein at least one atomizing apparatus is a rotary atomization device comprising:
a) a rotating component, which can be any structure, substance or force field suitable to transfer or generate rotational force;
b) a cylindrical part mounted for rotation, with a rotational axis perpendicular to the surfaces of the cylindrical part that have a circular perimeter, the cylindrical part being rotated by the rotating component;
c) a conduit, which guides the fluid to one of the surfaces of the cylindrical part that have a circular perimeter, the conduit comprising at least one of the following:
c1) tubing;
c2) at least one channel in the die mandrel of the blown-film extruder;
c3) at least one channel in the rotating component;
c4) at least one channel in the cylindrical part.

5. The method of claim 4, wherein the atomization device further comprises at least one pumping apparatus coupled to the conduit, the pumping apparatus being any device suitable to impel the fluid through the conduit.

6. The method of claim 4, wherein the surface receiving the fluid on the cylindrical part is concave.

7. The method of claim 4, wherein the surface receiving the fluid on the cylindrical part has a central indentation where fluid is delivered without flow interruption.

8. The method of claim 4, wherein the cylindrical part is a disc.

9. The method of claim 4, wherein the conduit is thermally insulated, partially or on its entirety.

10. The method of claim 2, wherein at least one atomizing apparatus is a nozzle-based atomization device comprising:
a) a plurality of spraying nozzles oriented to atomize the fluid towards the inner surface of the bubble;
b) a central flow distributor to which the spraying nozzles are connected;
c) a conduit, which guides the fluid to the flow distributor, the conduit comprising at least one of the following:
cl) tubing;
c2) at least one channel in the die mandrel of the blown-film extruder.

11. The method of claim 10, wherein the atomization device further comprises at least one pumping apparatus coupled to the conduit, the pumping apparatus being any device suitable to impel the fluid through the conduit.

12. The method of claim 10, wherein the conduit is thermally insulated, partially or on its entirety.

13. The method of claim 1, where at least one substance is at least one of the following:
a) a substance that prevents the film from sticking to itself;
b) an antimicrobial substance;
c) a deodorant;
d) a substance that increases the electrical conductivity of the film;
e) a substance that decreases the electrical conductivity of the film;
f) a substance that absorbs electromagnetic radiation of selected wavelengths;
g) a substance that reflects electromagnetic radiation of selected wavelengths;
h) a fragrance or scent;
i) a lubricant;
j) a substance with oxidizing activity;
k) a pesticide;
l) a biocide;
m) an animal attractant;
n) a food preservative;
o) an animal repellent;
p) a rust inhibitor;
q) a substance that decreases the surface tension of liquids;
r) an adhesive substance;
s) a drug;
t) a hormone.

14. A blown-film extruder, comprising:
a) parts typical of a blown-film extruder, including, but not limited to:
a1) at least one polymer feeder;
a2) at least one extruder screw;
a3) at least one die adapter;
a4) a die, with a die mandrel and a die ring;
a5) at least one air ring;
b) at least one atomizing apparatus affixed to the blown-film extruder at a location suitable for placing atomized material on the inner surface of a bubble during blown-film extrusion.

15. A blown-film extruder as described in claim 14, wherein at least one atomizing apparatus is affixed to the die mandrel of the blown-film extruder.

16. A blown-film extruder as described in claim 14, wherein at least one atomizing apparatus is a rotary atomization device comprising:
a) a rotating component, which can be any structure, substance or force field suitable to transfer or generate rotational force;
b) a cylindrical part mounted for rotation, with a rotational axis perpendicular to the surfaces of the cylindrical part that have a circular perimeter, the cylindrical part being rotated by the rotating component;
c) a conduit, which guides the fluid to one of the surfaces of the cylindrical part that have a circular perimeter, the conduit comprising at least one of the following:
cl) tubing;
c2) at least one channel in the die mandrel of the blown-film extruder;
c3) at least one channel in the rotating component;
c4) at least one channel in the cylindrical part.

17. A blown-film extruder as described in claim 14, wherein at least one atomizing apparatus is a nozzle-based atomization device comprising:
a) a plurality of spraying nozzles oriented to atomize the fluid towards the inner surface of the bubble;
b) a central flow distributor to which the spraying nozzles are connected;
c) a conduit, which guides the fluid to the flow distributor, the conduit comprising at least one of the following:
cl) tubing;
c2) at least one channel in the die mandrel of the blown-film extruder.

18. An improvement to a blown-film extruder to allow the application of at least one substance to the inner surface of a bubble during blown-film extrusion, comprising at least one atomizing apparatus affixed to the extruder at a location suitable for placing atomized material on the inner surface of the bubble during blown-film extrusion.

19. An improvement to a blown-film extruder as described in claim 18, wherein at least one atomizing apparatus is affixed to the die mandrel of the blown-film extruder.

20. An improvement to a blown-film extruder as described in claim 18, wherein at least one atomizing apparatus is a rotary atomization device comprising:
a) a rotating component, which can be any structure, substance or force field suitable to transfer or generate rotational force;
b) a cylindrical part mounted for rotation, with a rotational axis perpendicular to the surfaces of the cylindrical part that have a circular perimeter, the cylindrical part being rotated by the rotating component;
c) a conduit, which guides the fluid to one of the surfaces of the cylindrical part that have a circular perimeter, the conduit comprising at least one of the following:
cl) tubing;
c2) at least one channel in the die mandrel of the blown-film extruder;
c3) at least one channel in the rotating component;
c4) at least one channel in the cylindrical part.

21. An improvement to a blown-film extruder as described in claim 18, wherein at least one atomizing apparatus is a nozzle-based atomization device comprising:
a) a plurality of spraying nozzles oriented to atomize the fluid towards the inner surface of the bubble;
b) a central flow distributor to which the spraying nozzles are connected;
c) a conduit, which guides the fluid to the flow distributor, the conduit comprising at least one of the following:
cl) tubing;
c2) at least one channel in the die mandrel of the blown-film extruder.

22. A business related research and development method for determining how to modify a blown-film extruder to apply a substance to the inner surface of a blown bubble, comprising:
a) supplying a blown-film extruder; and
b) adding an atomizing apparatus to the blown-film extruder at a location suitable for placing atomized material on the inner surface of a bubble during blown-film extrusion.
